(19) United States
(12) Patent Application Publication
(10) Pub. No.: US 2003/0021860 A1
(43) Pub. Date: Jan. 30, 2003

(54) Twin screw compounding/injection molding apparatus and process

(76) Inventors: Jason B. Clock, Kettering, OH (US); Randy L. Frappier, Huber Heights, OH (US)

Correspondence Address: KATHRYN A. MARRA, ESQ., DELPHI TECHNOLOGIES, INC., Legal Staff, Mail Code: 480-414-420, P.O. Box 5052, Troy, MI, 48007-5052, US

(21) Appl. No.: 09/911,791

(22) Filed: Jul. 24, 2001

(51) Int. Cl. B29C 45/54

(52) U.S. Cl. 425/204; 264/211.23; 264/328.1; 264/347; 425/208; 425/562; 425/574

(57) ABSTRACT

A compounding/injection molding apparatus includes an extruder configured to receive and compound raw materials, a plunger disposed longitudinally within the extruder, and a mold positioned at the outlet end of the extruder and configured to receive the compounded raw materials. The extruder includes first and second screws intermeshed with each other along at least a portion of the length thereof. The plunger is typically positioned longitudinally within a bore defined within the first screw and is translatable within the bore. The mold is a press capable of receiving molten thermoplastics and molding the molten thermoplastics to the desired shapes. The method for using the apparatus includes adding at least one material to the extruding unit proximate a first end thereof, compounding the material, transporting the material to an outlet port proximate a second end of the extruding unit, and transferring the material from the outlet port to the mold.

### BACKGROUND

Plastic materials are molded by a myriad of different operations to form various components that are utilized in a wide range of applications. The plastic materials are compounded by heating and blending the plastic materials (generally in pellet form) to form a homogenous composition or “melt.” The plastic materials may be further compounded with various types of reinforcing fibers or polymeric materials to improve the mechanical properties of parts molded from the plastic materials. The compounded melt, which is in a liquid or semi-liquid state, is then formed in a mold under pressure.

The molding operation may be an extrusion process. One type of extrusion process comprises a screw extruder in which the melt is forced under pressure into the mold. The screw extruder generally comprises a housing having a cylindrical barrel portion surrounding a centrally positioned motor driven screw. At a first end of the barrel is a feed housing containing a feed opening through which the plastic material is introduced into the barrel. The screw comprises “flights,” which are raised portions helically wrapped about a shaft of the screw. The feed material is conveyed by the flights upon rotation of the shaft toward a second end of the barrel. Oftentimes, two screws are adjacently positioned within the barrel such that the flights of each screw interengage and provide enhanced compounding and conveyance of the feed to the second end of the barrel. As the feed is conveyed along the length of the barrel, it is melted into the liquid or semi-liquid state. The melt, once it reaches the second end of the barrel, is then referred to as “extrudate.” The melting of the feed to form the extrudate may be effectuated by the addition of heat to the barrel, by the shearing of the palletized feed caused by the rotation of the screw, or a combination of both.

The actual forming of the plastic material into a finished or intermediate component is achieved through the injection of the extrudate into the mold and the curing of the extrudate in the desired shape of the object. The extrudate is injected into a die of the mold through a nozzle disposed at the second end of the barrel. The die comprises a mold cavity and core portions that define the shape of the object to be molded. The mold cavity and its associated core portions are pressurized for a period of time to “set” the extrudate, thereby allowing the finished object to maintain its shape once the extrudate is cured. In order to produce an object that will not deform upon its removal from the mold, the mold may be cooled.

### SUMMARY

A twin screw compounding/injection molding apparatus and its method of use is described below. The apparatus includes an extruder configured to receive and compound raw materials, a plunger disposed longitudinally within the extruder, and a mold positioned at the outlet end of the extruder and configured to receive the compounded raw materials. The extruder includes first and second screws intermeshed with each other along at least a portion of the length thereof.

The method for using the apparatus includes adding at least one material to the extruder proximate a first end thereof, compounding the material, transporting the material to an outlet port proximate a second end of the extruder, and transferring the material from the outlet port to the mold.

### BRIEF DESCRIPTION OF THE DRAWINGS

FIG. 1 is a perspective view of a twin screw compounding/injection molding apparatus;

FIG. 2 is a schematic view of a twin screw extruder showing an injection plunger disposed within a first screw thereof;

FIG. 3 is a schematic exploded view of the screws of a twin screw extruder;

FIG. 4 is a cross sectional view of a twin screw extruder;

FIG. 5 is a plan view of a section of a twin screw extruder having screws with interrupted flights;

FIG. 6 is a plan view of a twin screw extruder having a mixing section;

FIG. 7 is a cross sectional view of a keyway of a mixing section;

FIG. 8 is a plan view of a section of a twin screw extruder having an injection plunger disposed within a screw thereof wherein the screw includes flights of varying angles;

FIG. 9 is a perspective view of a hydraulically operated press;

FIG. 10 is a plan view of a mechanically operated press;

FIGS. 11-14 are schematic drawings illustrating the process of producing a melt for injection into a mold from granulated raw material; and

FIG. 15 is a side elevation view of a check ring contemplated for use with an embodiment of the present invention.

### DETAILED DESCRIPTION

A compounding/injection molding apparatus may be used for in-line compounding of plastic materials to form various molded components including, but not being limited to, cabin componentry for use in vehicle occupant compartments of motor vehicles, marine vehicles, and aircraft. The apparatus employs a single extruder having screws that run continually to partition an extrudate into “shots,” or batches of material, that are conveyed to an injection mold by a plunger disposed longitudinally within one of the screws. Once the material is conveyed to the injection mold, the plunger retracts into the screw and the next extrudate is introduced to the extruder and partitioned into shots. Although the extruder is depicted as having two screws, it should be understood that any number of screws may be arranged to provide compounding and injection molding of the plastic materials.

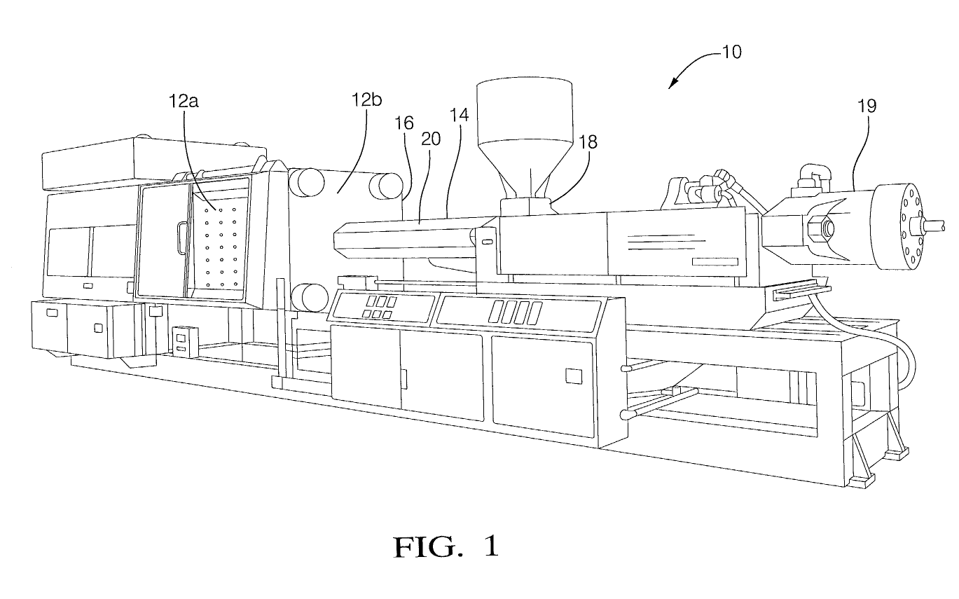

Referring to FIG. 1, a compounding/injection molding apparatus having twin screws is shown generally at 10 and is hereinafter referred to as “apparatus 10”. Apparatus 10 comprises an extruding unit, shown generally at 14, a mold (not shown) disposed between two platens 12a and 12b (not shown), a press, shown generally at 16, and a primary inlet port 18. Press 16 may be hydraulically, electrically, or mechanically operated.

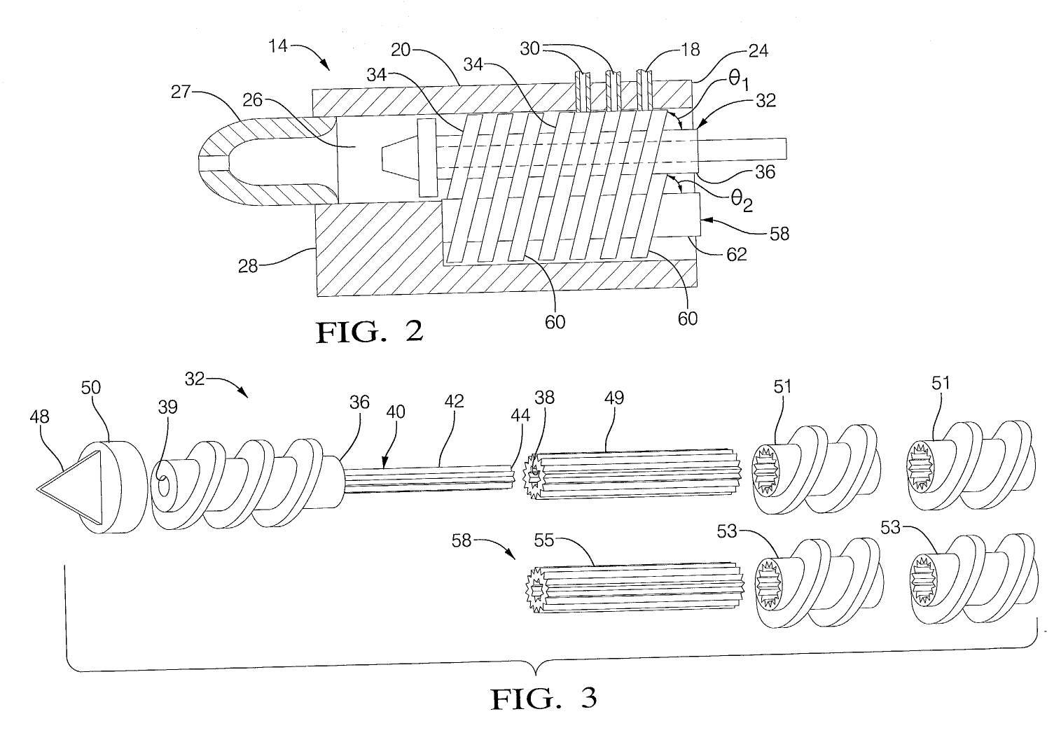

Extruding unit 14 comprises a barrel portion 20 and first and second screws (shown below with reference to FIGS. 2, 3, 5, 6, and 8) positioned within an internal cavity. Barrel portion 20 is dimensioned to accommodate both screws as well as raw materials to be compounded and mixed to produce the desired finished or intermediate product. The screws are preferably intermeshed along at least a portion of the length thereof in order to increase the mixing efficiency of extruding unit 14.

The outer dimensions of the screws substantially correspond to the inner dimensions of the internal cavity in order to provide a close fit of the screws within the internal cavity while also allowing rotational movement thereof. Positioned within the first screw is an injection plunger (shown below with reference to FIGS. 2, 3, and 4)

The screws may be driven by drive motors one of which is shown at 19 and includes drivers (shown below with reference to FIG. 3) defined longitudinally therein that are dimensioned to be received on rotor shafts of the drive motors.

Referring now to FIG. 2, an embodiment of extruding unit 14 includes barrel portion 20 having primary inlet port 18 located at a front end 24 thereof to accept material for processing and an outlet port 26 located at a back end 28 thereof to permit the removal of processed material for injection into the press. The processed material, which is in liquid form when it reaches outlet port 26, is generally known as “melt”. A plurality of secondary inlet ports 30 may be positioned longitudinally along the length of barrel portion 20 to accept material at various stages of the compounding process. A check ring 50 may be connected to the injection plunger 40 to control the flow of melt out of barrel portion 20 into the shot chamber. The shifting of the check ring facilitates the movement of the melt through the nozzle portion of the apparatus. An example of a check ring to be used in an embodiment of the present invention is illustrated in FIG. 15.

The check ring is shown generally at 50. Check ring 50 is connected to the injection plunger to control the flow of melt out of the barrel portion. The shifting of check ring 50 facilitates the movement of the melt over a nozzle 27 and into the shot chamber. Radially formed flutes 67 extend longitudinally along nozzle 27, the surface of which is highly polished so as to allow a smooth flow to be maintained. Check ring 50 includes a sleeve 68 disposed about a body portion 64. A seat 66 is disposed at an end of body portion 64 opposite nozzle 27. A conduit 69 extends longitudinally through body portion 64 to accommodate the flow of the melt therethrough, thereby providing fluid communication between the barrel portion and the shot chamber. Seat 66 includes an outer surface 70 configured and dimensioned to reduce the shearing effect of melt as it flows through check ring 50 and to minimize the amount of melt build up at the inlet of body portion 64. Seat 66 further includes a threaded portion 71 configured and dimensioned to be received in an aperture 39 disposed in a shaft of the first screw.

Check ring 50 includes a screw portion for the securement to a screw of the extruder unit. Check ring 50 includes a ring portion and a seat portion. There is a reduced flow path in between the seat portion and the ring portion in order to reduce shear and material hang up. In addition, a larger flow area is positioned between the ring portion and an internal member which connects the seat portion to the body retainer portion.

After the melt flows through check ring 50, it flows through a nozzle 27 disposed at the outlet port and into the mold. Nozzle 27 forms a “press-seal” connection at the interface of the extruding unit and the mold to limit the amount of melt that may “drool” from the outlet port during the operation of the apparatus.

Referring back now to FIG. 2, the first screw, shown generally at 32, is longitudinally mounted within barrel portion 20 and comprises a plurality of screw flights 34 protruding away from the outer surface of a shaft 36 at an angle θ₁. Screw flights 34 are defined by a protrusion attached to or integrally formed with shaft 36 and are arranged in a slanted helical pattern (as described below) along the length of shaft 36. Screw flights 34 may be formed so as to be contiguous with adjacently positioned screw flights, thereby causing material in extruding unit 14 to be continuously pushed through barrel portion 20 to outlet port 26.

The second screw, shown generally at 58, comprises a plurality of screw flights 60 protruding away from the outer surface of a shaft 62. Screw flights 60, in a manner similar to screw flights 34, are arranged in a slanted helical pattern such that an angle θ₂ of screw flights 60 corresponds with angle θ₁ of screw flights 34. Second screw 58 is positioned adjacent to first screw 32 such that screw flights 34, 60 of each screw 32, 58 intermesh with each other. The intermeshing of screws 32 and 58 serves to increase the pumping efficiency of extruding unit 14.

Referring now to FIG. 3, a screw shaft 49 of first screw 32 is formed to define a bore 38 therein. Bore 38 extends longitudinally and completely through screw shaft 49. Bore 38 defines a hollow portion in screw shaft 49 in which a portion 42 of injection plunger 40 is longitudinally disposed. Shaft 36 is axially connected to injection plunger 40 and includes aperture 39 for receiving check ring 50. Axially interconnectable flighted sections 51 are removably positioned over screw shaft 49 to form shaft 36 of first screw 32.

In a similar configuration, axially interconnectable flighted sections 53 are also positioned over a screw shaft 55 to form the shaft of second screw 58. Portion 42 of injection plunger 40, is positioned inside screw shaft 49.

Injection plunger 40 provides for the transfer of the melt from the outlet port of the barrel portion through the check ring, which is positionable in either an “open” or a “closed” position, to the press, where the melt is deposited into the mold and is formed into the final desired shape. Injection plunger 40 is disposed within screw shaft 49 and is longitudinally translatable along a length thereof in response to an actuation signal. The actuation signal is received from a controller unit of the press.

Injection plunger 40 comprises portion 42 having a front end 44 and a back end and a plunging element 48 fixedly connected to the back end. Plunging element 48 includes a check ring 50 disposed therearound. Check ring 50 is configured and dimensioned to engage the inlet port of the mold. Portion 42 is dimensioned such that front end 44 thereof extends out of screw shaft 49 and is attachable to the actuator that can effectuate the movement of injection plunger 40 longitudinally within shaft 49. Plunging element 48 is configured and dimensioned to allow the melt entering the outlet port pushed from screw flights 34 to flow through check ring 50 and around nozzle 27 from screw flights 34 to the outlet port where it is pushed into the mold.

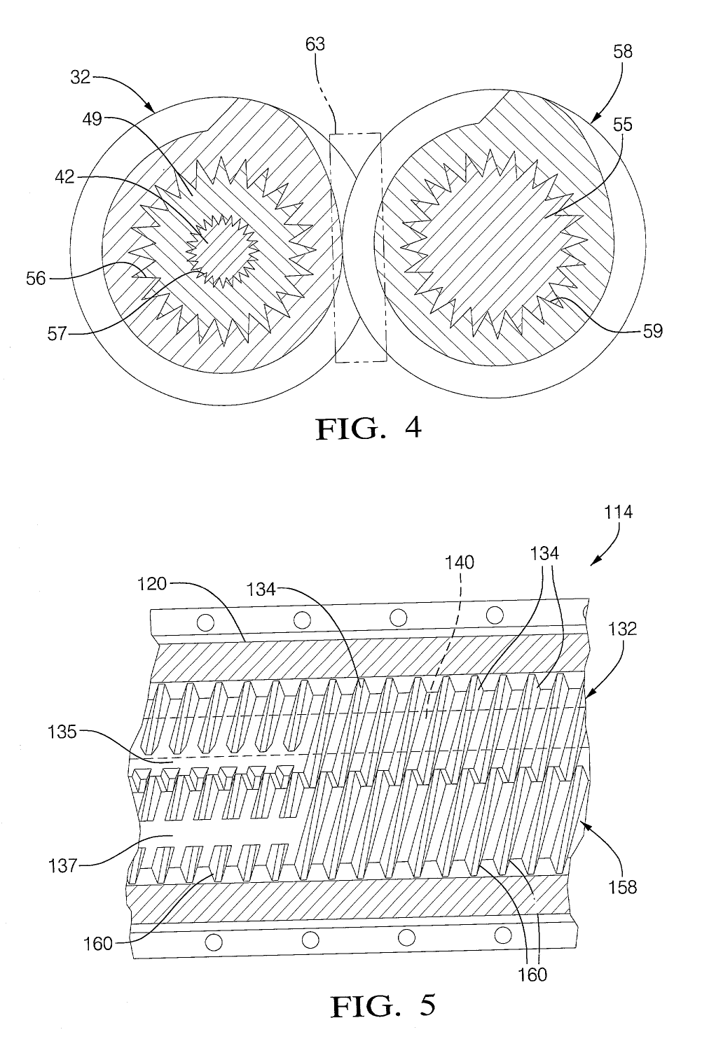

Referring to FIG. 4, the relationship between portion 42 of the injection plunger, screw shaft 49, and the axially interconnectable flighted sections of first screw 32 is shown. Screw shaft 49 includes a plurality of splines 56 disposed longitudinally on an outer surface thereof. The faces of splines 56 engage correspondingly configured surfaces disposed on the inner surfaces of each axially interconnectable flighted section. Screw shaft 49 also includes a plurality of splines 57 disposed longitudinally on an inner surface thereof. The faces of splines 57 engage correspondingly configured surfaces disposed on the outer surface of rod portion 42.

Also shown with reference to FIG. 4 is the relationship between screw shaft 55 and the axially interconnectable flighted sections of second screw 58. Screw shaft 55 includes a plurality of splines 59 disposed longitudinally on an outer surface thereof, the faces of which engage correspondingly configured surfaces disposed on the inner surfaces of the axially connectable flighted sections. The driving of either screw shaft 49 or screw shaft 55 (or both in conjunction with each other) effectuates the rotation of screws 32, 58 such that each screw 32, 58 intermeshes with the other in an intermesh area 63.

Another embodiment of extruding unit, a portion of which is shown generally at 114 in FIG. 5, may include a first screw 132 having screw flights 134 that may be configured to include interruptions 135 therein in order to allow material to flow therebetween during operation of extruding unit 114. Injection plunger 140 is disposed longitudinally within first screw 132 in a manner similar to that shown in FIG. 2. A second screw 158 having screw flights 160 may also include interruptions 137 to enhance the flow of material. Such a configuration enables material in a barrel portion 120 of extruding unit 114 to pass between screw flights 134, 160 longitudinally along the length of screws 132, 158 as it is pushed through extruding unit 114 by screw flights 134, 160, thereby increasing the residence time of the material within extruding unit 114 and causing the melt to flow to shot chamber 126.

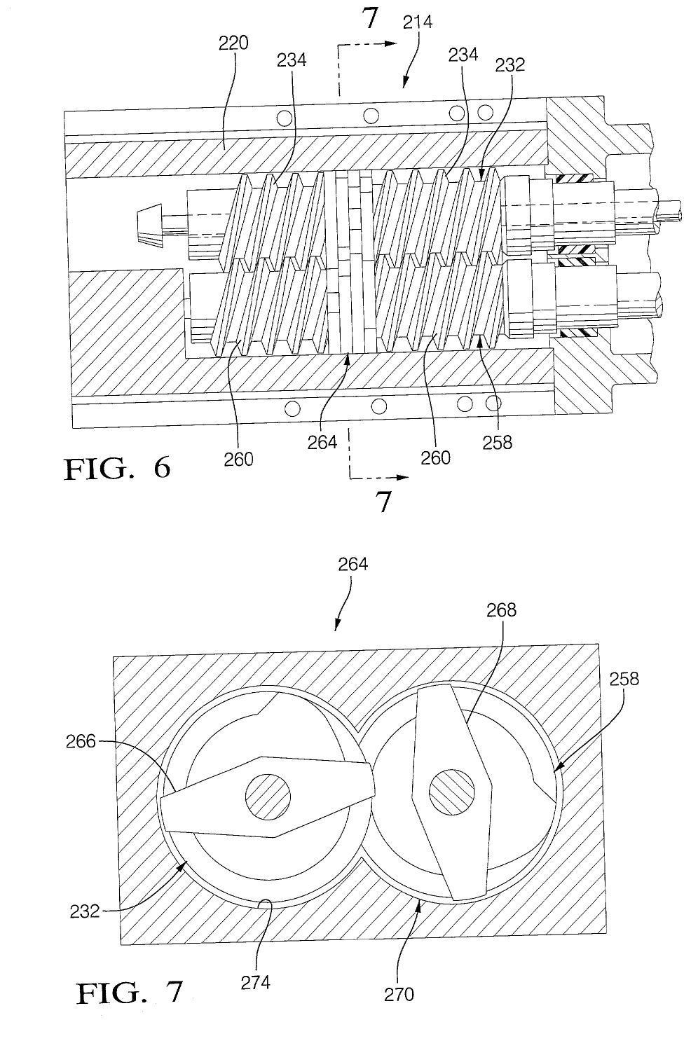

Referring now to FIG. 6, another embodiment of an extruding unit is shown generally at 214. Extruding unit 214 comprises a first screw 232 and a second screw 258 mounted in a barrel portion 220. Screws 232, 258 respectively include screw flights 234, 260, which are typically axially interconnected flighted sections that may be separated by at least one mixing section, shown generally at 264. Referring to FIG. 7, mixing section 264 comprises a first lobe element 266 disposed on first screw 232 intermediate two screw flights and a second lobe element 268 disposed on second screw 258 intermediate two screw flights disposed within a keyway, shown generally at 270. Keyway 270 includes two frustocircular openings positioned and configured therein to accommodate lobe elements 266, 268. Lobe elements 266, 268 are typically cammed members that may be elliptical in shape, as shown, or substantially triangular in shape with rounded points (not shown), and are configured to operate in conjunction with each other upon rotation of screws 232, 258. In particular, lobe elements 266, 268 are dimensioned to contact and sweep an inside surface 274 of keyway 270. A portion 242 of an injection plunger disposed longitudinally with first screw 232 is also illustrated.

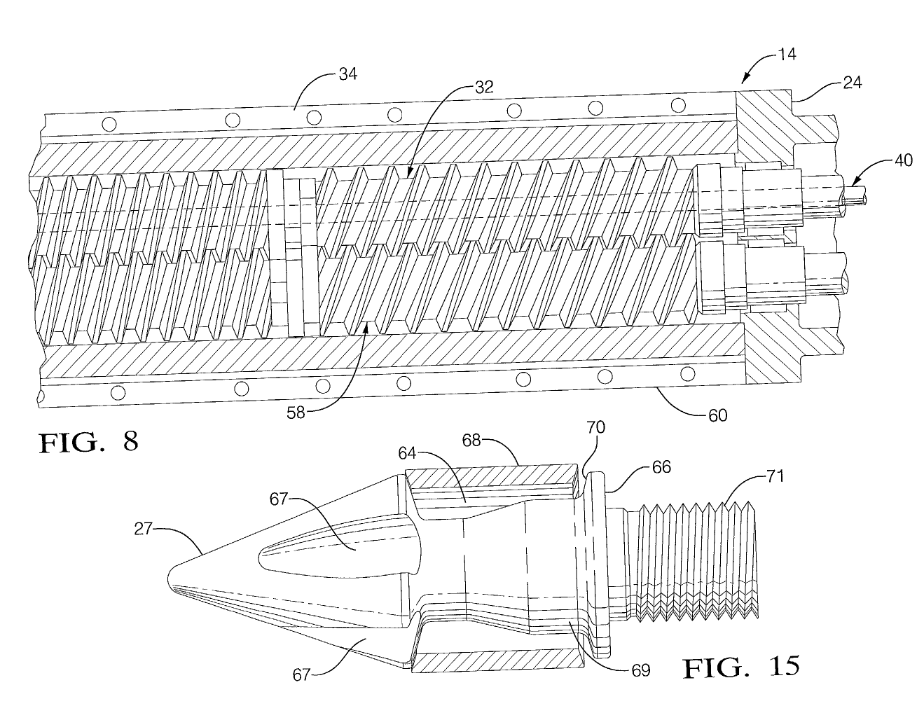

All of the screw flights, regardless of the respective embodiment into which they are incorporated, are configured to define a slanted helical pattern. Referring now to FIG. 8, the slant or “pitch” of the helical pattern may vary over the overall length of each screw 32, 58 in order to cause material in extruding unit 14 to translate through particular sections thereof at varying speeds. In particular, if raw materials are heated in a section of extruding unit 14 proximate a front end 24 thereof, the pitch of screw flights 34, 60 may form a more acute angle with the longitudinal axes of screws 32, 58 in order to more slowly translate the materials through that heated section to the outlet portion where the materials are engaged by the plunging element of injection plunger 40 and forced into the press. If, however, it is desired to have the materials translate a section of extruding unit 14 more quickly, the pitch of screw flights 34, 60 may be configured to form a less acute angle with the longitudinal axes of screws 32, 58.

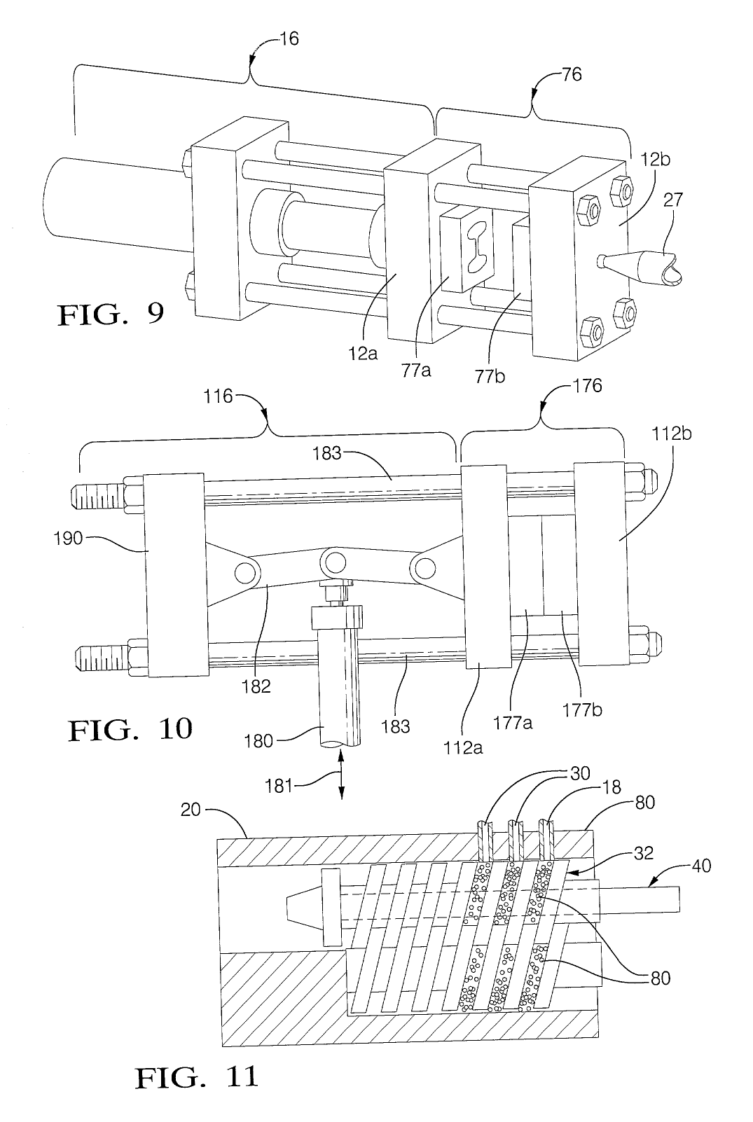

Referring now to FIG. 9, press 16 and the mold, shown generally at 76, are illustrated relative to nozzle 27 of the extruding unit. As shown, press 16 is hydraulically operated. Other configurations, as stated above, may also be utilized. Mold 76 includes first platen 12a and second platen 12b. A die is disposed between platens 12a, 12b and is configured to have a male die half 77a and a female die half 77b wherein the female die half 77b includes a contact surface against which the compounded material is deposited in preparation for molding. Male die half 77a is then configured to be complementary in shape to female die half 77b and is received therein. Press 16 provides a compressive force that biases male die half 77a toward female die half 77b to shape the compound material into the desired shape of the finished or intermediate component.

In FIG. 10, a press 116 and a mold 176 are shown. Press 116 is mechanically operated to provide a compressive force sufficient to mold a finished or intermediate component. Mold 176 comprises a first platen 112a and a second platen 112b. First platen 112a is movable along tie rods 183, and second platen 112b is stationary. Mold 176 comprises a male die half 177a and a female die half 177b. Male die half 177a is fixedly disposed on first platen 112a, and female die half 177b is fixedly disposed on second platen 112b. Upon manipulation of an actuating cylinder 180 in the directions of an arrow 181, a linkage assembly 182 disposed between a stationary mount 190 and first platen 112a causes the translation of first platen 112a (and male die half 177a) along tie rods 183 to effectively open or close mold 176.

Referring back to FIG. 1, primary inlet port 18 is described. Primary inlet port 18 is typically a hopper or a similar type of gravimetric feeder that is dimensioned to meter the amount of material deposited therein, thereby ensuring that the raw materials fed to barrel portion 20 for engagement by the screws are of the proper amount to produce the desired finished part.

Referring now to FIGS. 11 through 14, a process of producing thermoplastic composite componentry by utilizing the in-line compounding capabilities of the apparatus is described. The process comprises feeding material 80 into extruding unit 14 through primary inlet port 18, compounding material 80, and injecting the compounded material 80 into the press where it is molded to a final shape and form. In the process, polymer compounding and injection molding are achieved in a batch process in which both operations are combined into a single step.

Material 80 used to produce the thermoplastic componentry typically includes resins, which may be linear or branched olefinic polymers such as high or low density polyethylenes (HDPE, LDPE), polypropylene, or similar materials. The resins may be combined with other materials such as blowing agents or crosslinking agents. The resins are generally in the form of granules or pellets to facilitate their handling and addition to primary inlet port 18 and secondary inlet ports 30. Other materials that may be added to produce the thermoplastic componentry include, but are not limited to, talc, fibers, or similar materials.

Referring now to FIG. 11, the feeding of the resins and other materials into extruding unit 14 is facilitated by depositing material 80, which may be in granular or pellet form, into primary inlet port 18. Material 80 may also be deposited into at least one of the secondary inlet ports (not shown). Primary inlet port 18, as well as each of the secondary inlet ports, includes a gravimetric feeder, which may be a hopper. The gravimetric feeder may be used to measure the amount of material 80 added to barrel portion 20 of extruding unit 14, thereby metering the batch size to allow specific amounts of resin and other materials to be used in the process such that the proper amount thereof is used to produce a single injection molded part. Use of metered amounts of material 80 minimizes the amount of waste generated, reduces heat cycling within extruding unit 14, and prevents or at least minimizes the amount of material degradation that may occur as a result of heat. During the addition of material 80 to extruding unit 14, injection plunger 40 is retracted within first screw 32.

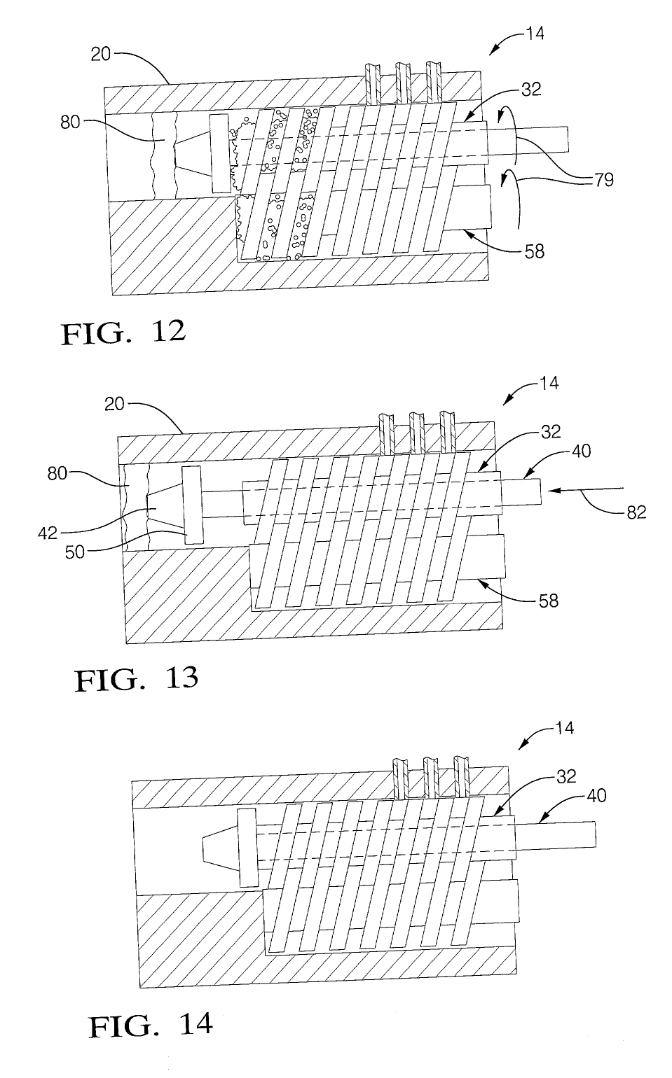

Once material 80 is added to extruding unit 14, the compounding thereof is effectuated by screws 32, 58, as is illustrated in FIG. 12. Screws 32, 58 are driven in the directions shown by arrows 79 to cause the movement of screws 32, 58 in a co-rotating orientation. Alternately, screws 32, 58 may be driven in opposing directions (not shown) to cause the movement of the screws in a counter-rotating orientation. Either rotational orientation advances material 80 along the length of barrel portion 20. Advancement of material 80 along the length of barrel portion 20 subjects material 80 to heat (if extruding unit 14 is heated) as well as increasing shear, thereby plasticizing material 80 to produce melt of the desired composition and consistency. The incorporation of a mixing section, as shown at 264 in FIGS. 6 and 7, further serves to masticate material 80, thereby increasing the plasticability thereof. Once plasticized, material 80 is in a liquid or semi-liquid state and is of a viscosity sufficient to enable it to be injected into the press.

As shown in FIG. 13, injection of material 80 into the press is effectuated through the translation of injection plunger 40 within first screw 32 longitudinally in the direction of an arrow 82. Once material 80 is ready to be molded, material 80 is transferred through the check ring and through the nozzle by extension of injection plunger 40 from first screw 32. When the proper amount of material 80 enters the press, the check ring is closed, and injection plunger 40 is retracted back into first screw 32, as is shown in FIG. 14. Subsequent shots of raw material can then be mixed to supply the press with the thermoplastic extrudate to form additional pieces.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A thermoplastic compounding/injection molding apparatus, comprising:
an extruder configured to receive and compound raw materials, said extruder comprising,
a first screw, and
a second screw intermeshed with said first screw along at least a portion of a length of said first screw;
a plunger disposed longitudinally within said first screw; and
a mold configured to receive said compounded raw materials, said mold being positioned at an outlet end of said extruder.

2. The apparatus of claim 1 wherein said raw materials are resins.

3. The apparatus of claim 2 wherein said compounded raw materials are molten thermoplastics.

4. The apparatus of claim 1 wherein said plunger comprises,
a rod portion,
plunging a element disposed on an end of said rod portion, and
a check ring disposed on said plunging element to prevent backflow of said compounded raw materials into a barrel portion of said first screw.

5. The apparatus of claim 1 wherein said mold is actuatable by a press.

6. The apparatus of claim 5 wherein said mold is configured to receive compounded raw materials into a cavity thereof.

7. The apparatus of claim 5 wherein said mold is hydraulically actuatable.

8. The apparatus of claim 5 wherein said mold is mechanically actuatable.

9. An apparatus for extruding a material and injecting said material into a mold, comprising:
a first screw having a bore defined therein;
a second screw intermeshed with said first screw along at least a portion of a length of said first screw; and
a plunger disposed within said bore of said first screw.

10. The apparatus of claim 9 wherein said bore is configured, positioned, and dimensioned to allow for the longitudinal translation of said plunger therethrough.

11. The apparatus of claim 10 wherein said bore includes a plurality of splines longitudinally disposed along a length thereof, said splines being configured to engage a plurality of splines longitudinally disposed along a length of an outer surface of said plunger to prevent axial movement of said plunger within said bore.

12. The apparatus of claim 9 wherein said first screw and said second screw are disposed within a barrel portion.

13. The apparatus of claim 12 wherein an addition of said material to said apparatus is effectuated by passing said material through at least one inlet port disposed on said barrel portion.

14. The apparatus of claim 13 wherein the addition of said material to said apparatus is via a gravimetric device.

15. The apparatus of claim 9 wherein said plunger comprises:
a rod having a first end and a second end, said first end being connectable to an actuator configured to effectuate the translational motion of said rod; and
a plunging element disposed on said second end of said rod, said plunging element being configured and dimensioned to facilitate the transfer of said material into said mold.

16. The apparatus of claim 15 wherein said plunging element includes a check ring disposed thereon, said check ring being configured and dimensioned to allow for the flow of said material from a first side to a second side thereof to be received by a port of said mold of said apparatus.

17. The apparatus of claim 9 wherein said first screw and said second screw include at least one mixing section disposed therein.

18. The apparatus of claim 9 wherein flights of said first screw and said second screw are of varying angles relative to shafts of said first screw and said second screw.

19. A method of producing a thermoplastic for subsequent molding, comprising:
adding at least one material to an extruding unit proximate a first end thereof;
compounding said at least one material;
transporting said at least one material to an outlet port proximate a second end of said extruding unit; and
transferring said at least one material from said outlet port to a mold.

20. The method of claim 19 wherein said compounding of said at least one material and said transporting of said at least one material is a simultaneous operation.

21. The method of claim 19 wherein said compounding of said at least one material comprises:
melting said at least one material; and
mixing said at least one material.

22. The method of claim 19 wherein said transferring of said at least one material from said outlet port to said mold is effectuated by an injection of said material from said outlet port to said mold.

23. The method of claim 22 wherein said injection of said material from said outlet port to said mold is effectuated by a plunger.

24. The method of claim 23 wherein said injection of said material from said outlet port to said mold by said plunger is followed by a retraction of said plunger.
